(19) United States
(12) Patent Application Publication
(10) Pub. No.: US 2003/0061381 A1
(43) Pub. Date: Mar. 27, 2003

(54) INTERFACE APPARATUS AND METHOD FOR WIRELESS DATA COMMUNICATION

(76) Inventors: MITCH A. BRISEBOIS, ONTARIO (CA); PAUL DOUGLAS MCDONALD, ONTARIO (CA); SUSAN KATHLEEN COLEMAN, QUEBEC (CA)

Correspondence Address: SMART & BIGGAR, P.O. BOX 2999, STATION D, 55 METCALFE STREET, SUITE 900, OTTAWA, ON, K1P5Y6, CA

(21) Appl. No.: 09/468,119

(22) Filed: Dec. 21, 1999

(51) Int. Cl. G06F 15/16

(52) U.S. Cl. 709/245

(57) ABSTRACT

Interface apparatus can be designed to allow wireless connections to be established between a computer and a computer controlled component such as a printer, scanner, etc. These interface apparatus do not require any modifications within the computer controlled component, as the interface apparatus is coupled to the computer controlled component via a standard interface such as a Universal Serial Bus (USB) cable. The interface apparatus converts data information from a first format required by the standard interface into a second format required by a wireless data network, and vice versa. With the use of such interface apparatus numerous wireless private networks can be established including both computers with wireless data connections and other components that normally cannot attach and/or remove data unit headers.

### RELATED APPLICATIONS

U.S. patent application entitled “WIRELESS NETWORK COMMUNICATIONS” by Brisebois et al, filed on the same day as the present application, and assigned to the assignee of the present application, discloses and claims subject matter related to that of the present invention and is herein incorporated by reference.

### FIELD OF THE INVENTION

This invention relates generally to wireless communications and more specifically to apparatus and methods used to establish wireless data communications.

### BACKGROUND OF THE INVENTION

There are currently a large number of devices within corporations and households that require physical wiring in order to communicate with each other. This is particularly evident in an office environment where a “fully connected” computer may have wiring connections to a monitor, a keyboard, a printer, and a central server. Some computers may further be physically coupled to scanners and/or facsimile machines. To accommodate the needs of a typical office worker, networks have been established in a majority of medium to large office environments to reduce the required number of printers and other possible shared devices such as scanners. These networks further allow for each networked computer to be connected to a central server in which files and news can be shared, overall backup and security operations for the entire network can be performed, internal email services can be established, and internal and external communications can be controlled. The functionality of these networks have been deemed essential to the efficient operation of an office workplace.

There are a number of key problems with these network configurations as they currently exist. For one, network designs can become extremely complex as more devices are added, resulting in complicated wiring arrangements in many cases. In these wiring arrangements, the network is configured by physically laying wire, which is time consuming and difficult to adjust when adding or removing devices. Further, in some wiring arrangements, computers may be coupled within the network to some devices, such as printers, only through other computers that must stay powered in order for the connection to remain. Another key problem with wired networks as currently designed is the physical limitation the actual wiring itself causes on the network. The use of wired connections essentially limits the network to devices that are within a single location, with few options for remote access. Hence, as currently designed, wired networks are not practical for the growing mobile workforce.

One attempt to overcome the problems experienced by current wired network configurations is to use wireless communications based upon the operation of a new standard called Bluetooth. A Bluetooth transceiver as currently conceived is a short range radio transceiver operating in the 2.45 GHz unlicensed band. The implementation of Bluetooth transceivers within a wide variety of devices such as mobile telephones, laptop computers, printers, and electronic cameras is envisioned for the future. For instance, Internet connections for a laptop could be established via a Bluetooth link to a mobile telephone and further a standard wireless link to a wireless telephone network coupled to a Publicly Switched Telephone Network (PSTN). Further ideas include having a Bluetooth link between an electronic camera and a printer, the printer producing copies of all photographs taken by the camera.

There are a number of problems with the Bluetooth vision for wireless devices. For one, the short-range links have a limited applicability and do not solve the problems discussed herein above concerning remote access to a wired network or the problems of mobile workers. Further, for Bluetooth to be successful, a large proportion of corporations that produce the computers, mobile telephones, printers, cameras, etc must agree to implement a common new standard. Currently, this is not the case with many major corporations refusing to recognize and implement the new standard. Yet further, the frequency range selected for Bluetooth communications is the same as several established local wireless technologies which could cause packets of data from different sources to interfere, resulting in degraded performance.

Access to wired networks from remote locations outside the network's wiring architecture is currently possible, though these techniques do not reduce the other problems discussed herein above for a wired network. One option for achieving this remote access is by allowing people to dial up and register with the network. One problem with this is the difficulties of dialling up and logging into a network which is typically a secure network for a corporation. Further, although it is possible to connect through dial up, this technique does not allow for the connection to be maintained at all times as these connections are strictly “on” or “off”.

Hence, an improvement is required that would allow access to apparatus such as printers without the use of a wired network or a dial-up procedure. Preferably this improvement would be implemented without the adoption of a new standard and further would allow access to such apparatus by a mobile workforce.

### SUMMARY OF THE INVENTION

The preferred embodiments of the present invention is directed to apparatus and methods that will allow for wireless connections to be established between a computer and a computer controlled component such as a printer, scanner, etc. The present invention preferably requires no modifications within the computer controlled component, as an interface apparatus is preferably coupled to the computer controlled component via a standard interface such as a Universal Serial Bus (USB) cable. This interface apparatus converts data information from a first format required by the standard interface into a second format required by a wireless data network, and vice versa.

The present invention, according to a first broad aspect, is an apparatus for controlling data communications between a component interface port and a wireless network transceiver. In operation, this apparatus receives digital data from the component interface port and attaches a data unit overhead including source and destination addresses to the digital data in order to generate a data unit. In this case, the source address is a predefined data address for the apparatus and the destination address is a stored data address. The apparatus next outputs the data unit to the wireless network transceiver for transmission to a wireless network.

The present invention, according to a second broad aspect, is an apparatus similar to the first broad aspect. In operation, this apparatus receives a data unit from the wireless network transceiver that comprises digital data and a data unit overhead including source and destination addresses, the destination address being a predefined data address for the computing device. Next, the apparatus removes the data unit overhead from the data unit and outputs the digital data to the interface port.

In preferable embodiments, the operations of both the first and second broad aspects are included within a single apparatus. Further, the source and destination addresses are preferably Internet Protocol (IP) addresses.

The present invention, according to a third broad aspect, is an interface apparatus arranged to be coupled to a digital data processing component. In this aspect, the interface apparatus includes an interface port coupled in series with a computing device and a wireless network transceiver. In operation, the interface port receives digital data in a first format, that is preferably the Universal Serial Bus (USB) format, from the digital data processing component, converts the digital data from the first format to a second format, and outputs the digital data in the second format. The computing device, in operation, receives the digital data in the second format from the interface port, attaches a data unit overhead including source and destination addresses to the received digital data in order to generate a data unit, and outputs the data unit. In this case, the source address is a predefined data address for the interface apparatus and the destination address is a stored data address. Finally, in operation, the wireless network transceiver receives the data unit and transmits it to a wireless network that is preferably a third generation (3G) wireless network.

The present invention, according to a fourth broad aspect, is an interface apparatus similar to that of the third broad aspect. In this case, in operation, the wireless network transceiver receives a data unit from a wireless network that comprises digital data in a first format and a data unit overhead including source and destination addresses and outputs the data unit. In this embodiment, the destination address is a predefined data address for the interface apparatus. In operation, the computing device next receives the data unit from the wireless network transceiver, removes the data unit overhead from the data unit, and outputs the digital data in the first format. Finally, in operation, the component interface port receives the digital data in the first format, converts the received digital data from the first format to a second format that is preferably the USB format, and outputs the digital data in the second format to the digital data processing component.

In preferred embodiments, the interface apparatus can perform the operations of both the third and fourth aspects. Further, the source and destination addresses are preferably Internet Protocol (IP) addresses and the interface apparatus further includes a memory device.

In further aspects, the present invention is a method of transmitting digital data received from a digital data processing component to a wireless network and a method of forwarding digital data received within a data unit from a wireless network to a digital data processing component.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The preferred embodiment of the present invention is described with reference to the following figures, in which:

FIG. 1 is a block diagram illustrating a third generation wireless network;

FIG. 2 is a logical block diagram illustrating a Virtual Private Network (VPN) of mobile stations according to embodiments of the present invention;

FIG. 3 is a signalling diagram illustrating the control and data signalling within the VPN of FIG. 2 during a sample operation of a mobile station accessing a web page;

FIG. 4 is a block diagram illustrating a third generation wireless network interface apparatus according to preferred embodiments of the present invention;

FIG. 5 is a logical block diagram illustrating a VPN of interface apparatus of FIG. 4 according to embodiments of the present invention;

FIG. 6 is a signalling diagram illustrating the control and data signalling within the VPN of FIG. 5 during a sample operation of a mobile station initiating a printing operation;

FIG. 7 is a logical block diagram illustrating a VPN according to embodiments of the present invention encompassing both a VPN of mobile stations and a Local Area Network (LAN); and

FIGS. 8A and 8B are sample tables illustrating first and second private network group tables that could be stored within the intelligent peripheral and the web-based server of FIG. 7 respectively.

### DETAILED DESCRIPTION OF THE PREFERRED EMBODIMENT

The present invention, according to preferred embodiments, is directed to an interface apparatus implemented as a mobile station within a third generation (3G) wireless network. As is described herein below, the interface apparatus preferably maintains a link with a 3G wireless network and further is coupled to a component, such as a printer or scanner, that cannot traditionally be linked to a wireless network. With the use of the interface apparatus according to preferred embodiments, these components can be linked to the 3G wireless network as will be described herein below.

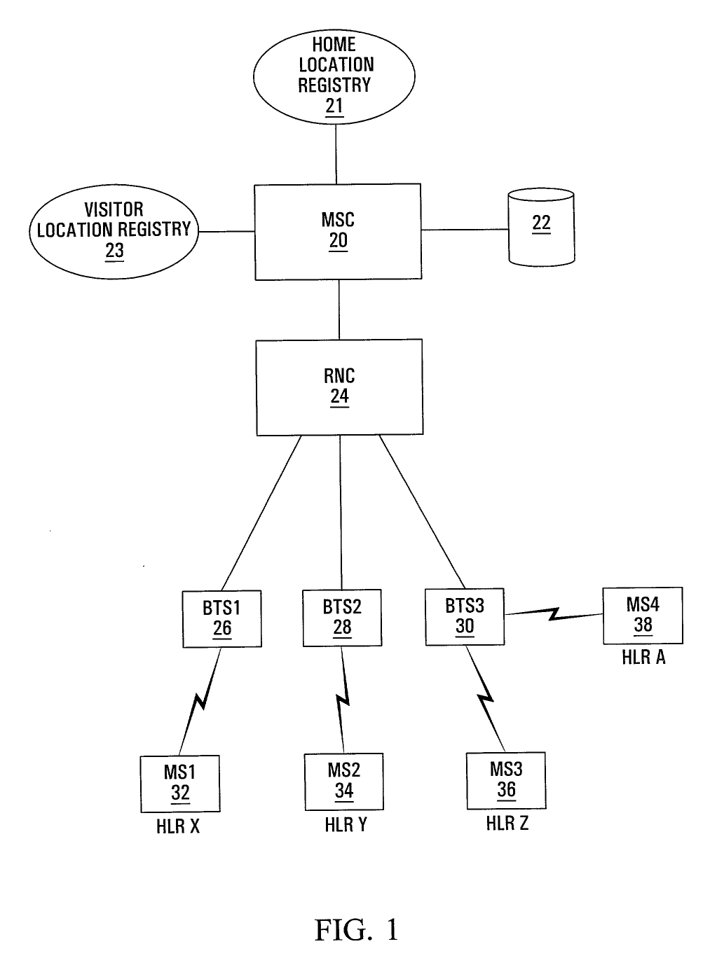

Preferably, the 3G wireless network in which the interface apparatus is implemented is a Universal Mobile Telecommunications System (UMTS) network which complies with the system defined by the International Telecommunications Union (ITU) as IMT-2000. Such a 3G wireless network has additional functionality compared to previous wireless technologies as is described below with reference to FIG. 1. Although this description is specific to a 3G wireless network, it should be recognized that other wireless technologies could be utilized that have similar functionality.

FIG. 1 illustrates a 3G wireless network that could be used to implement an interface apparatus according to the present invention as a mobile station. This 3G wireless network includes a core network comprising Mobile Switching Center (MSC) 20; a server referred hereinafter as an intelligent peripheral 22, a home location registry 21, a visitor location registry 23 and a Radio Network Controller (RNC) 24 each independently coupled to the MSC 20; first, second and third base transceiver stations (BTSs) 26,28,30, each coupled to the RNC 24; and first, second, third and fourth mobile stations 32,34,36,38 communicating, preferably with data communications, with the first BTS 26, the second BTS 28, the third BTS 30 and the third BTS 30 respectively. The MSC 20 is further coupled to other MSCs (not shown) and a Transit Switching Center (TSC) (not shown) which is further coupled to a PSTN (not shown), the other MSCs and PSTN communicating with a plurality of fixed wire and/or mobile stations (not shown).

Within the network of FIG. 1, the MSC 20 controls the connecting of mobile stations within a predefined cell cluster area assigned to the particular MSC 20 with other telephone stations, the other telephone stations being other mobile stations or fixed wire telephone stations coupled to the PSTN (not shown). A number of mobile stations are assigned to the MSC 20, each of these mobile stations having a corresponding Home Location Registration (HLR) with the MSC 20, these HLRs being stored within the home location registry 21. In the case shown in FIG. 1, the mobile stations 32,34,36,38 have been assigned respective HLR X, HLR Y, HLR Z, and HLR A. Mobile stations that are within the cell cluster area of the MSC 20, but that are not part of the home location registry 21, are included within the visitor location registry 23 and assigned a Visitor Location Registration (VLR). The MSC 20 communicates with the MSC(s) that the mobile station(s) within the visitor location registry are assigned in order to determine which services, if any, to provide the particular mobile station(s).

The intelligent peripheral 22 is designed to control service features that are available to the mobile stations within the cell cluster area of the MSC 20. Examples of possible service features controlled by the intelligent peripheral include call waiting, call forwarding and call blocking, each of which are well-known in the wired telephone environment. Further, the intelligent peripheral 22 maintains a registry of all the mobile stations assigned to the MSC 20 by maintaining a database of all their HLRs.

3G wireless networks are designed to allow for the communications between the mobile stations and the BTSs to be of variable bandwidth. Within the network of FIG. 1 the control of this variable bandwidth between mobile stations 32,34,36,38 and their respective BTSs 26,28,30,30 is preferably performed within the RNC 24. In this case, other components that require an increase in the communication bandwidths to be established must request such bandwidth levels from the RNC 24. The RNC 24 controls the bandwidth levels of the BTSs 26,28,30 to ensure that the overall bandwidth level for each of the BTSs is below a maximum threshold level that the particular BTS can accommodate. In some circumstances, the RNC 24 can initiate hand-offs for one or more mobile stations from a first BTS to a second BTS in order to lower the bandwidth requirements on the first BTS. Preferably, the RNC 24 exclusively controls the reducing of bandwidths between devices as required. In one particular embodiment, the bandwidth between a mobile station and its BTS is reduced to a minimum level if no signals are sent for a predetermined time period.

One important possible operation of the 3G wireless network results from this variable bandwidth capability. Since the bandwidth is adjustable from a very low level to a high level limited only by the bandwidths of the BTS and mobile station utilized, a very low bandwidth connection can be permanently maintained between a mobile station and its corresponding BTS. This essentially allows a mobile station within a 3G wireless network, such as an interface apparatus according to preferred embodiments of the present invention, to possibly have an “always on” option; this “always on” option allowing for many different capabilities that previous wireless networks did not have.

One such possible capability is the generation of a Virtual Private Network (VPN) among mobile stations of a 3G wireless network. Within a VPN, a set of telephone stations is implemented as nodes for data communications; the telephone stations within the VPN together being referred to as a private network group. A VPN can include a combination of mobile stations and fixed wire telephone stations but, in either case, each of the nodes must maintain connections with the other nodes. Hence, the “always on” capability of the mobile stations within a 3G wireless network allows these mobile stations to be implemented within a VPN.

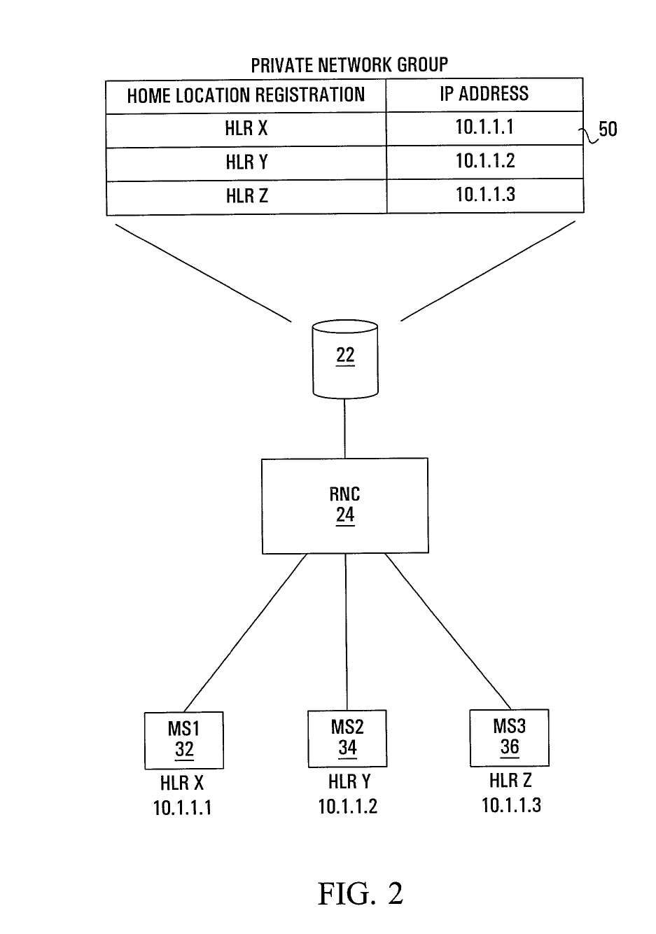

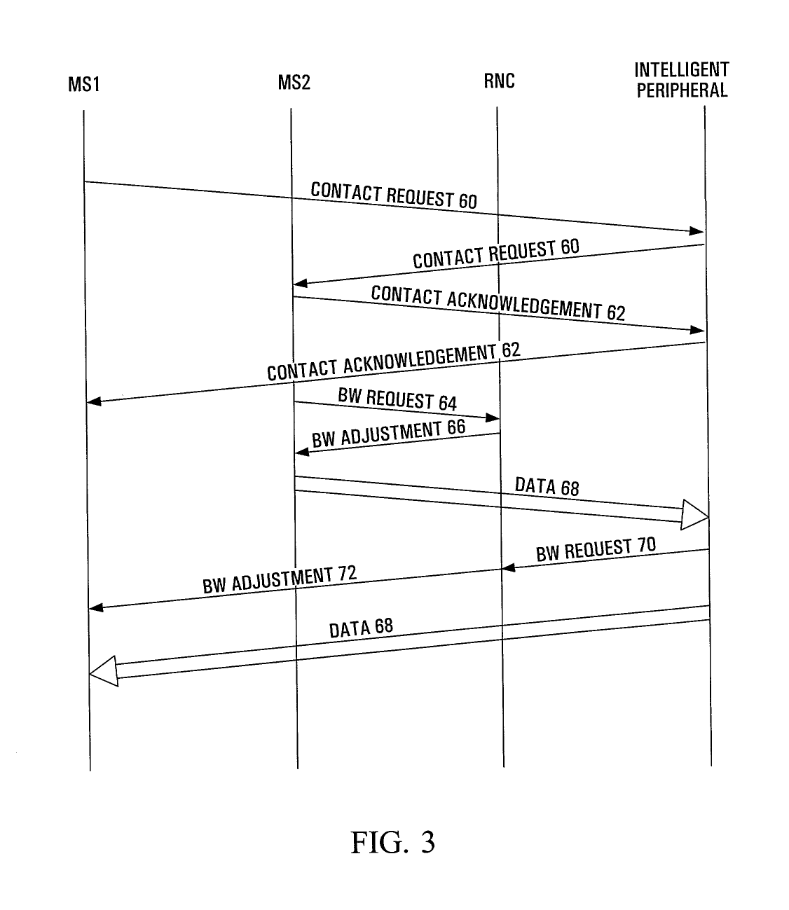

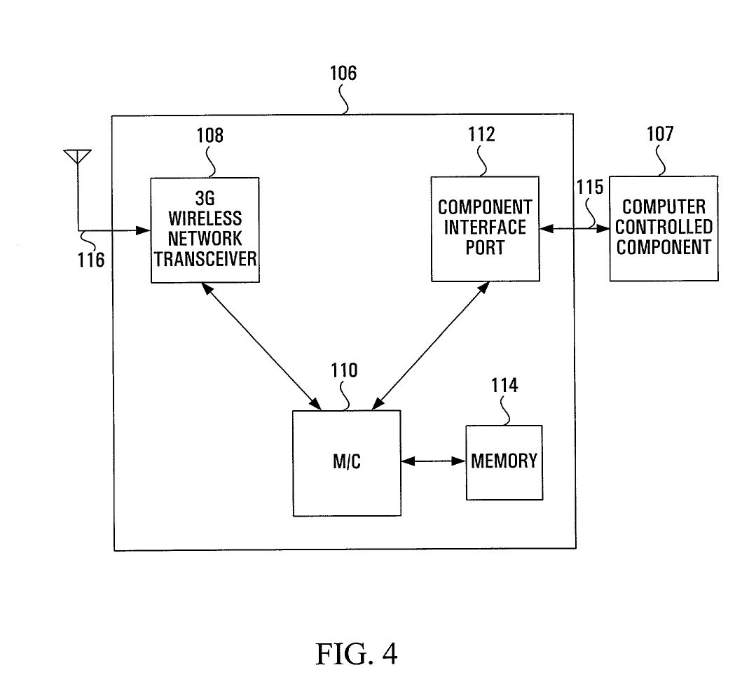

An interface apparatus according to a preferred embodiment of the present invention is implemented as a mobile station within a VPN for data communications. In this preferred embodiment, the interface apparatus maintains a connection with the other nodes of the VPN in order to remain a part of the network. Such a preferable interface apparatus that is implemented within a VPN will be described in detail with reference to FIG. 4 after a description of a sample VPN with reference to the logical block diagram of FIG. 2 and a sample operation of the VPN of FIG. 2 with reference to FIG. 3; these other descriptions providing a context for the interface apparatus of FIG. 4.

In FIG. 2, the VPN comprises the intelligent peripheral 22, the RNC 24 coupled to the intelligent peripheral 22, and the first, second and third mobile stations 32,34,36 coupled independently to the RNC 24. The coupling between the RNC 24 and each of the mobile stations 32,34,36 is “always on” with a minimal bandwidth being maintained while the mobile station is in operation. The fourth mobile station 38 is not illustrated on FIG. 2 as this mobile station is not included as a node within the VPN in this example and therefore, as described below, will not have access to the mobile stations 32,34,36 of the VPN. The other components of a wireless network as shown in FIG. 1 are not shown in the logical block diagram of FIG. 2 as these components preferably do not require modifications from their well-known operations in a 3G wireless network. In the situation of FIG. 2, there are three mobile stations 32,34,36 included as members of the private network group; these mobile stations possibly being interface apparatus as will be described below. In other embodiments of VPNs, there could be more or less than three mobile stations.

As can be seen in FIG. 2, the intelligent peripheral 22 includes a private network group table 50 for the private network group of interest. In other embodiments, in which a plurality of private network groups are established, it should be understood that each private network group would have a corresponding private network group table stored within the intelligent peripheral 22. The private network group table 50 of FIG. 2 comprises a list of all the HLRs corresponding to the members of the private network group of interest as well as a respective data address for each HLR, the data address preferably being an Internet Protocol (IP) address. This list of HLRs is a subset of the overall list of HLRs within the home location registry 21. In the embodiment illustrated in FIG. 2, the HLRs corresponding to the first, second and third mobile stations are stored in the list along with their respective Internet Protocol (IP) addresses. Hence, HLR X that corresponds to the first mobile station 32 is stored along with IP address 10.1.1.1; HLR Y that corresponds to the second mobile station 34 is stored along with IP address 10.1.1.2; and HLR Z that corresponds to the third mobile station 36 is stored along with IP address 10.1.1.3. Although the embodiments described herein below use IP addresses as the data addresses for the HLRs, it should be recognized that other data addressing schemes could be utilized. For example, the data addresses could be words such as the names of the people corresponding to the HLRs.

The generating of the private network group table 50 can take place in a number of ways. In one embodiment, the users of the VPN inform the service provider of the 3G wireless network the data addresses that correspond to each mobile station that is a member of the private network group. In this case, the service provider then manually enters the information and stores it within the intelligent peripheral 22. In another embodiment, the users themselves have the option of initiating and/or modifying a private network group table through a connection with the intelligent peripheral 22. This connection preferably comprises an Internet interface in which a user can log in with a login identification and password or another security administration technique.

In one possible operation of the VPN of FIG. 2 as will be described below with reference to the signalling diagram of FIG. 3, each of the mobile stations 32,34,36 are portable computers with a 3G wireless modem installed, the portable computers together forming an Intranet. To form the Intranet, each of the portable computers is preferably running a web-based interface program such as Netscape Communicator 4.0 produced by Netscape Communications Corporation of Mountain View, Calif. and at least one of the computers is preferably running a web-based server program such as Internet Information Server (IIS) produced by Microsoft Corporation of Redmond, Wash. This web-based server program allows the particular computer to operate as a host for one or more web pages and/or operate as an email central server. In some embodiments, a computing device is included within the Intranet, the exclusive purpose of which is to operate as a web-based server.

The signalling diagram of FIG. 3 illustrates an operation of accessing a web page within the VPN of FIG. 2. In the illustrated situation, a user of the first mobile station 32, a first computer within the Intranet, wants to access data information from the second mobile station 34, a second computer within the Intranet that has a web-based server capability. In this situation, the user of the first computer preferably enters the IP address corresponding to the second computer through the web-based interface program running on the first computer. In the preferred embodiment, the web-based interface program then sends a contact/data request signal 60 to the intelligent peripheral 22 via the BTS 26, the RNC 24 and the MSC 20. The contact/data request signal 60 comprises source and destination addresses which are the IP addresses of the first and second computers (10.1.1.1, 10.1.1.2) respectively in this case. Further, the contact/data request signal 60 preferably comprises a contact acknowledgement request and/or a data request. The data request possibly indicates the specific data information required or simply indicates the HTML file of a specific web page that is needed. If the contact/data request signal 60 is especially large, it may be necessary for the first mobile station 32 to initially request for an increase in bandwidth from the RNC 24 prior to the sending of the contact/data request signal 60.

Once the intelligent peripheral 22 receives the contact/data request signal 60, the peripheral 22 determines whether the HLR corresponding to the mobile station that sent the signal 60 is allowed access to the requested IP address listed as the destination address. In the case depicted in FIG. 3, this is done with the intelligent peripheral 22 determining whether the HLR X, that being the HLR for the first mobile station 32, is in the same private network group table as the HLR corresponding to the destination IP address (10.1.1.2), that being HLR Y of the second mobile station 34.

If the HLRs are not found to be in the same private network group table, the intelligent peripheral 22 preferably sends a contact denied signal to the first mobile station 32. This contact denied signal preferably informs the user of the first computer that the IP address requested is not available.

If the HLR of the requesting mobile station and the HLR of the destination address are within the same private network group table, the intelligent peripheral 22 forwards the contact/data request signal 60 to the HLR corresponding to the destination address, that being the second mobile station 34 in the case of FIG. 3. This forwarding takes place via the MSC 20, the RNC 24, and the second BTS 28. Similar to that described herein above, if the contact/data request signal 60 is especially large, it may be necessary for the intelligent peripheral 22 to initially request for an increase in bandwidth from the RNC 24 for the link between the second mobile station 34 and the second BTS 28 prior to the forwarding of the contact/data request signal 60.

After the second mobile station 34 receives the contact/data request signal 60, it performs actions similar to that done by a well-known computer with a web-based server capability. These actions include identifying the requests from the first computer and if possible responding as requested. In the case depicted in FIG. 3, the contact/data request signal 60 included a request for acknowledgement of contact and a data request for the download of a particular HTML file that corresponds to a web page and the associated files such as pictures to be displayed on the web page. Hence, the second mobile station 34 sends a contact acknowledgement signal 62 to the intelligent peripheral 22 for forwarding onto the mobile station corresponding to the source address (10.1.1.1) attached to the contact/data request signal 60, that being the first mobile station 32, and further, initiates the process of sending significant data information as will be described herein below. Similar to that described above for the contact/data request signal 60, the contact acknowledgement signal 62 comprises source and destination addresses, those being the IP addresses of the second and first mobile stations 34,32 (10.1.1.2, 10.1.1.1) respectively in this case. As well, the intelligent peripheral 22 processes the contact acknowledgement signal 62 in similar fashion as described herein above for the signal 60 such that the signal 62 is forwarded to the HLR corresponding to the destination address within the signal 62 (the HLR X of the first mobile station 32); after the peripheral 22 determines that the source mobile station 34 has an HLR within the same private network group table as the destination mobile station 32.

The process of sending significant data information from the second mobile station 34, as depicted in FIG. 3, begins with the second mobile station 34 sending a bandwidth request signal 64 to the RNC 24 via the second BTS 28. If the bandwidth request is accepted by the RNC 24, the RNC 24 sends bandwidth adjustment signals 66 to the second mobile station 34 and the second BTS 28, which increases the communication bandwidth to a level satisfactory for the transmission of the data signals 68. After the bandwidth is increased, the second mobile station 34 sends data signals 68 to the intelligent peripheral 22 via the second BTS 28, the RNC 24 and the MSC 20. For the example described above, these data signals 68 comprise an HTML file and associated files such as pictures to be displayed on the web page defined by the HTML file. Each of the data signals 68 comprises source and destination addresses that in this case correspond to the IP addresses of the second and first mobile stations (10.1.1.2, 10.1.1.1) respectively.

Once received at the intelligent peripheral 22, each of the data signals 68 is processed in the same manner as the contact/data request signal 60 and the contact acknowledgement signal 62. First, the intelligent peripheral 22 determines whether the HLR from which the signal is received is in the same private network group table as the HLR corresponding to the destination address. Next, after confirming that the HLRs are within the same table, the peripheral 22 forwards these data signals 68 to the HLR of the destination address, that being the first mobile station 32 in FIG. 3, via the MSC 20, the RNC 24 and the first BTS 26. Prior to the forwarding of the data signals 68, a BW request signal 70 is preferably sent from the intelligent peripheral 22 to the RNC 24 to increase the communication bandwidth between the first mobile station 32 and the first BTS 26. If the bandwidth request is accepted by the RNC 24, the RNC 24 sends bandwidth adjustment signals 72 to the first mobile station 32 and the first BTS 26, which increases the communication bandwidth to a level satisfactory for the transmission of the data signals 68. In alternative embodiments, no bandwidth request signal 70 is required to be sent from the intelligent peripheral 22 since the RNC 24 automatically increases the bandwidth, if possible, between the first mobile station 32 and the first BTS 26 when the data signals 68 arrive at the RNC 24 for forwarding to the first mobile station 32.

There are situations possible in which the bandwidth available for communications between a mobile station and its BTS is less than the requested bandwidth. Preferably, in this case, the mobile station requiring the increase in bandwidth is forwarded an insufficient bandwidth signal that indicates the situation to the user; resulting in further operations directed by the user being delayed until sufficient bandwidth can be allocated. Alternatively, the forwarding of the signals to or the transmitting of the signals from the particular mobile station simply continues with the limited bandwidth resulting in high transmission delays. In another alternative, the service provider offers “premium” bandwidth that would give an override priority to particular mobile stations that subscribe to increase the probability of sufficient bandwidth at all times.

It should be understood that mobile stations that are not listed within the private network group table 50 of FIG. 2, such as the fourth mobile station 38, would preferably have limited or no access to the mobile stations within the private network group. In some embodiments, user defined access to the mobile stations within the private network group from mobile stations outside the group is permitted. In these embodiments, the user defined access, which could include a list of control or data signals that are permitted, is preferably stored and processed within the intelligent peripheral 22. In the case that an attempt by a mobile station outside the private network group is made which is not permitted, the intelligent peripheral 22 sends access denied signals to the particular mobile station.

Within the sample operation described above with reference to FIG. 3 for the VPN of FIG. 2, the mobile stations are computers installed with 3G wireless network modems. The computers, in this setup, operate in similar fashion to well-known computers that send data packets to and receive data packets from a telephone line based modem. Similar to that for traditional modems, computers installed with a 3G wireless network modem must attach headers and footers to the packets, hereinafter referred to as the packet overhead, prior to the sending of the packets to the modem and must remove the packet overhead from the packets after receipt of data packets from the modem. This header comprises the source and destination addresses needed for proper processing and forwarding of the packets as described herein above for the sample operation of FIG. 3. In the case of the IP standard as described above, the source and destination addresses are both respective IP addresses.

When considering expanding the operations of the VPN of FIG. 2 to link mobile stations comprising components such as printers and scanners, a problem arise. These components generally cannot add/remove source and destination addresses from data information being sent/received; these addresses being required for the proper routing of data information through a VPN such as shown in FIG. 2. Hence, standard 3G wireless network modems cannot be used to link these components to a VPN and therefore to other mobile stations within an Intranet.

In normal use, many computer controlled components, such as printers and scanners, communicate with computers through the use of a Universal Serial Bus (USB) cable or another wired interfacing standard. In the sample case of a USB cable being utilized, each of the computer controlled components and the computer have a corresponding USB port which has one of the two ends of the USB cable connected. In operation, a USB port converts data information that is received from the corresponding apparatus or computer into a standard USB format capable of transmission over the USB cable and converts data information received from the USB cable into a normal format capable of being processed within the corresponding apparatus or computer. Similar operations are performed by other interfacing standards. One positive aspect of the USB standard is the wide usage of the standard by a large number of manufacturing corporations producing computers, printers, scanners and home entertainment systems and components. One negative aspect of this standard is that, as currently designed, it requires a fixed wire connection between the computer controlled component and the computer.

FIG. 4 illustrates a block diagram of an interface apparatus 106 according to preferred embodiments of the present invention that is coupled via an interface cable 115 to a computer controlled component 107 that cannot typically add/remove source and destination addresses. In this setup, the interface apparatus 106 can operate as a mobile station that links the computer controlled component 107 to nodes within a 3G wireless network, the computer controlled component 107 and one or more of these nodes possibly forming a VPN within the 3G wireless network. As shown, this interface apparatus 106 comprises a 3G wireless network transceiver 108 coupled in series with a micro-controller (M/C) 110 and a component interface port 112, the component interface port preferably being a USB port. Further coupled to the micro-controller 110 is a memory device 114 though in some embodiments the memory device 114 is comprised within the micro-controller 110. In operation, the component interface port 112 is connected to the particular computer controlled component 107 via the interface cable 115, which is preferably a USB cable, while the 3G wireless network transceiver 108 communicates with a 3G wireless network via an antenna 116 coupled to the transceiver 108.

The micro-controller 110 in this interface apparatus 106 compensates for the inability of the computer controlled component 107 to add and remove packet overheads. The interface apparatus 106 itself has an associated HLR defined for the 3G wireless network transceiver 108 used and further has an associated data address; that data address preferably being an IP address stored within the memory device 114 that can be accessed by the micro-controller 110 as it processes received data information.

The operation of the interface apparatus 106, according to preferred embodiments, will now be described in the case that the component interface port 112 is a USB port and the computer controlled component 107 is a printer. When signals, such as print request signals, arrive at the transceiver 108 from the 3G wireless network, the transceiver 108 converts them into standard data packets which are forwarded to the micro-controller 110. The micro-controller 110 then saves the source address of these data packets within the memory device 114, removes the packet overhead from the data packets, and forwards the data information contained within the data packets to the USB port 112. The USB port 112 further converts the data information into the standard USB format and forwards the data information to the printer.

When data information, such as a print confirmation signal, is sent from the printer to the interface apparatus 106, the USB port 112 receives the data information within USB standard format, removes the USB formatting, and forwards the data information to the micro-controller 110. The micro-controller 110 converts the data information into data packets with associated headers and footers. In the header, a destination address is attached that is consistent with the previously stored source address of the received signal and a source address is attached that is consistent with the data address of the interface apparatus. In other cases, in which no destination address is stored within the memory 114, a user of the computer controlled component 107 could be prompted to select a destination address. This prompting would be initiated by the interface apparatus 106, a network management tool running within the wireless network, or an algorithm running on the computer controlled component 107. The data packets are then forwarded to the 3G wireless network transceiver 108 before the transceiver 108 converts it to a form capable of being transmitted to the 3G wireless network and further transmits the signals via the antenna 116.

Although the interface apparatus 106 according to preferred embodiments of the present invention is described herein above for use with computer controlled components, this should not limit the scope of the present invention. In general, the interface apparatus according to embodiments of the present invention could be used with any component capable of digital data processing. The interface apparatus 106 could even be used with digital data processing components that are capable of adding/removing packet overheads, such as personal computers. For instance, a personal computer may have both a 3G wireless network modem and an interface apparatus as depicted in FIG. 4. The data addresses and HLRs of the two devices would be different while still operating from the same computer.

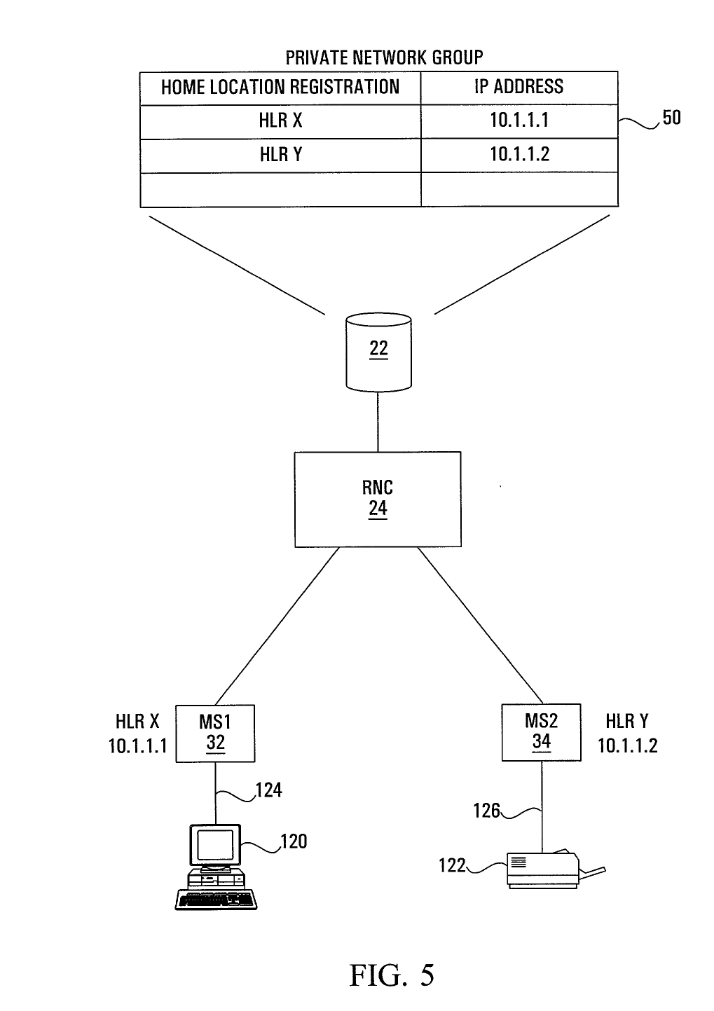

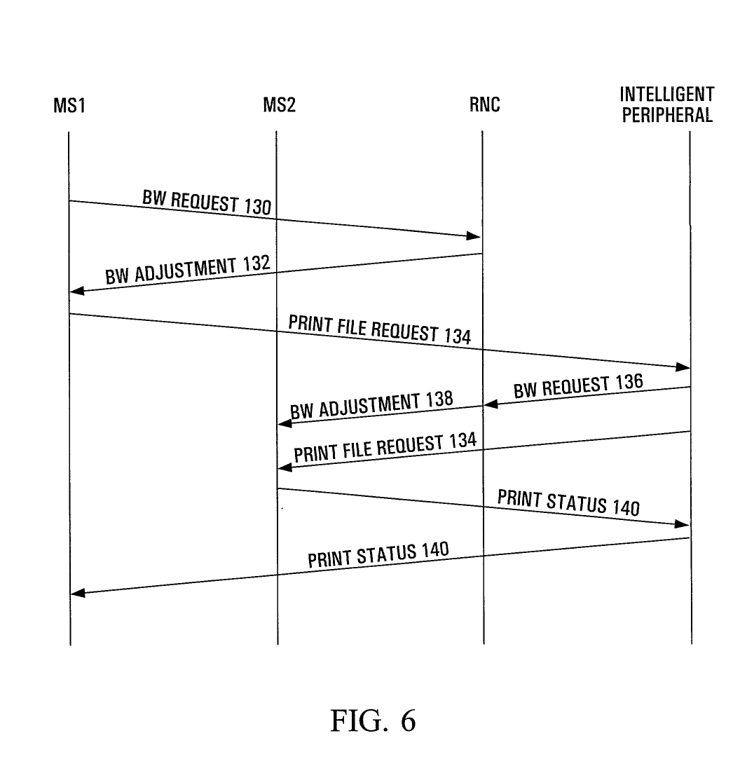

An operation of a VPN, according to a preferred embodiment of the present invention, is now described with reference to FIGS. 5 and 6 for the printing of a document via a 3G wireless network. FIG. 5 illustrates a logical block diagram of a VPN capable of having a computer print a document via the actual VPN. This diagram is virtually identical to that of FIG. 2, but with the first and second mobile stations 32,34 being coupled to a computer 120 and a printer 122 respectively. In this case, the first and second mobile stations 32,34 are each interface apparatus similar to that depicted in FIG. 4 that are coupled to the computer 120 and the printer 122 respectively via corresponding USB cables 124,126.

FIG. 6 is a signalling diagram illustrating a sample operation for the computer 120 to request a printing job with the printer 122 and the printer 122 subsequently sending a print status signal back to the computer 120. Initially, the first mobile station 32, that being an interface apparatus, receives a print file request which includes the data information to be printed from the computer 120. In one embodiment, the print file request has an indication to which printer the request is to be sent, the indication either specifically identifying the data address of the printer or the indication being used in a look-up table within the first mobile station 32 to determine the data address. In another embodiment, the first mobile station 32 reviews the print file request and determines that it is a request for printing; resulting in the first mobile station 32 sending the print file request to the data address saved within its memory for printing requests. In yet another embodiment, the first mobile station 32 is set to forward all files input through the USB port to a specific destination address. This could be used in the case that a user has two interface apparatus that are set within the same private network group table, the user coupling one to a USB port on his/her computer and coupling the other to the USB port on a printer.

Once the first mobile station 32 receives the print file request from the computer 120, the first mobile station 32 adds a packet overhead to the request including a destination address as discussed above and a source address corresponding to the predefined source address for the first mobile station 32. Next, as can be seen in FIG. 6, the first mobile station 32 preferably sends a bandwidth request 130 to the RNC 24 to increase the bandwidth between the first mobile station 32 and the first BTS 26. If accepted, the RNC 24 increases the bandwidth between the two devices by sending a bandwidth adjustment signal 132 to both the first mobile station 32 and the first BTS 26. Subsequently, the first mobile station 32 forwards a print file request 134 in a packet-based format to the intelligent peripheral 22.

The intelligent peripheral 22 then operates as described previously including determining if the HLR of the sending party is within the same private network group table as the HLR corresponding to the destination address. If the HLRs are within the same table, the intelligent peripheral 22 next sends a bandwidth request 136 to the RNC 24 to increase the bandwidth between the second mobile station 34 and the second BTS 28. If accepted, the RNC 24 sends a bandwidth adjustment signal 138 to the two devices to increase their communication bandwidth. Next, the intelligent peripheral 22 forwards the print file request signal 134 to the second mobile station 34.

The second mobile station 34, that in this case comprises an interface apparatus according to preferred embodiments of the present invention, proceeds to remove the packet overhead from the print file request 134 and forward the printing request to the printer 122. The printer 122 prints the requested file as usual or determines there is an error in the printing operation such as the printer 122 being out of paper. In either case, a print status signal is preferably sent back to the second mobile station 34, either comprising a print successful message or an error indication. The second mobile station 34 receives this print status signal; adds a packet overhead comprising a destination address corresponding to the previously received source address and a source address corresponding to the predefined source address of the mobile station 34; and forwards a packetized print status signal 140, via the second BTS 28, the RNC 24, the MSC 20, the processing of the intelligent peripheral 22, the MSC 20, the RNC 24 and the first BTS 26, to the first mobile station 32. The first mobile station 32 then removes the packet overhead and forwards the print status signal to the computer 120. It should be understood that further messages could be passed between the computer 120 and the printer 122 depending upon the particular printer postscript used.

Although the operation of FIG. 6 is specific to the communications between a computer and a printer using interface apparatus similar to that depicted in FIG. 4, it should be understood that numerous different embodiments could be implemented in a similar fashion. For instance, the first mobile station 32 could be a computer 120 installed with a 3G wireless network modem while the second mobile station 34 is still an interface apparatus coupled to the printer 122. Further, the interface apparatus of FIG. 4 could be used to link a different device that has a USB port or in the case that a different interfacing standard is used, a device that has a port specific for that interfacing standard. In this case, the component interface port 112 within the interface apparatus 106 would be modified for the specific standard utilized.

For example, interface apparatus according to one embodiment comprise component interface ports 112 based on an interface standard used between gaming devices. This embodiment allows a VPN to be established for the communication of gaming operations between a plurality of gaming devices that are not physically local to each other; thus allowing for multi-player game operations without physical connections between the actual gaming devices. In another example, the interface apparatus 106 is coupled via an interfacing cable to a digital camera that sends images in a digital image format to another component via the interface apparatus 106 and a wireless network. In yet further examples, the interface apparatus 106 could be modified to connect other components to a wireless network such as dispensing machines and remote controls.

Yet further, although the interface apparatus 106 is described as a separate device, it should be understood that it could be implemented within a particular device such as a printer or scanner. In this embodiment, application specific components could be used and/or components within the particular device could be modified in order to gain the functionality required.

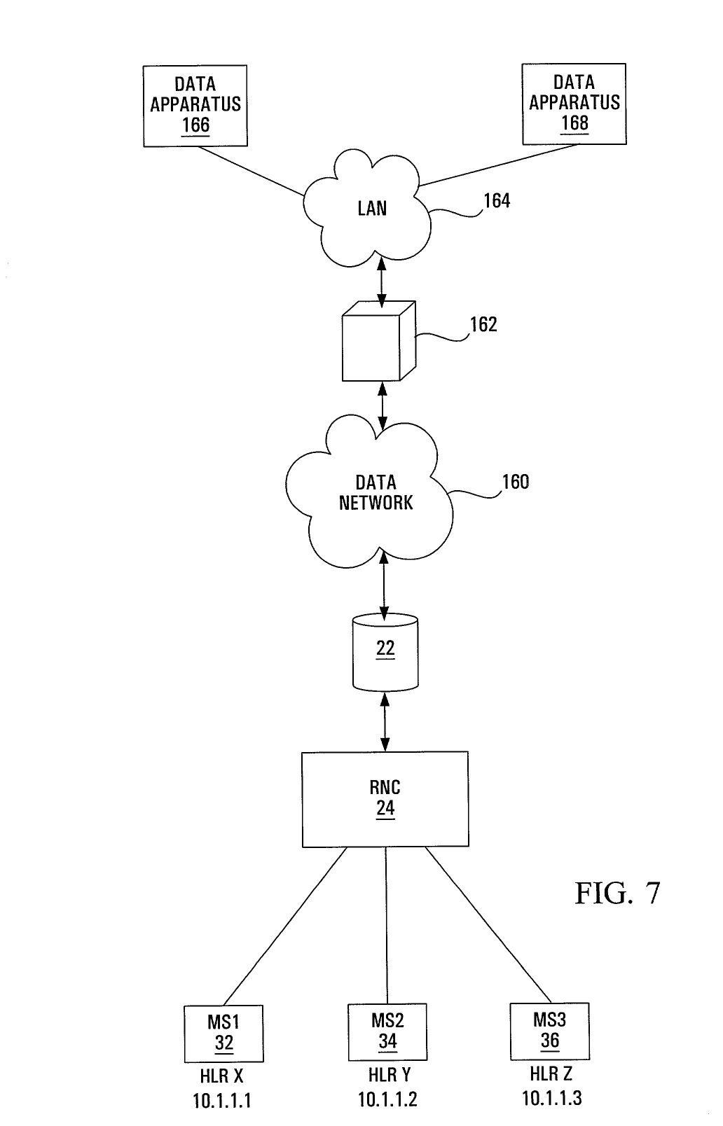

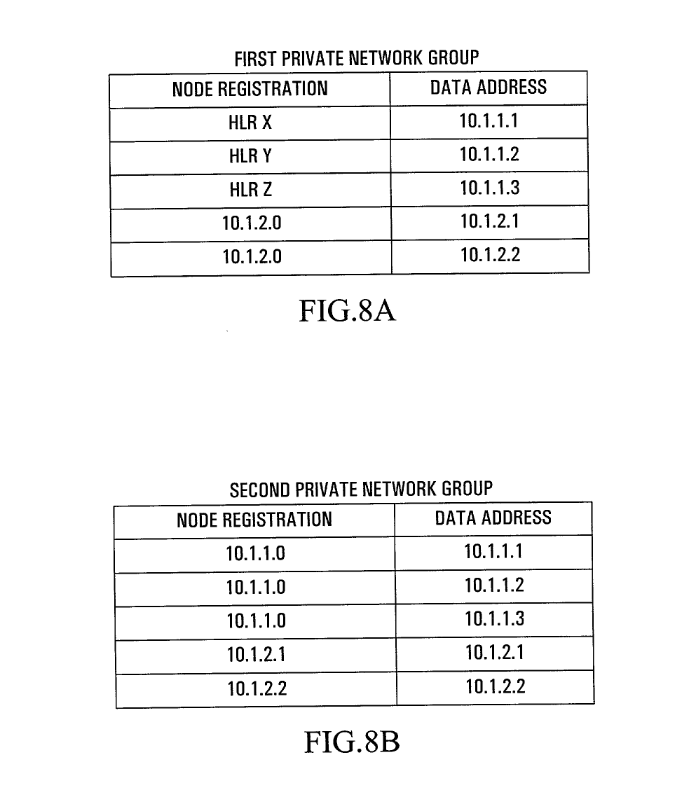

The above described implementation for an interface apparatus according to preferred embodiments of the present invention are directed at VPNs in which all of the nodes of the VPN are mobile stations within the same cell cluster. This should not limit the scope of the present invention. Some embodiments of VPNs, as are described herein below with reference to FIGS. 7, 8A and 8B, have a combination of wireless and fixed wire nodes and/or have wireless nodes within different cell clusters. In other embodiments, interface apparatus of the present invention are not implemented within a VPN at all. The intelligent peripheral 22 controlling access to the nodes of a VPN as described herein above is not necessary for the interface apparatus of the present invention to operate properly. For instance, a printer coupled to an interface apparatus according to one embodiment of the present invention could be accessed by any computer that knows its corresponding data address. In this case, the printer could be used remotely by anybody similar to the functionality of a facsimile machine. Further, in the case the component coupled to the interface apparatus is a facsimile machine, it could be possible for a user of a computer linked to the 3G wireless network to send a facsimile message to the facsimile machine without actually ever producing a hard copy of the message.

If the VPN implemented with an interface apparatus according to the preferred embodiments were to be implemented with wireless and fixed wire nodes and/or wireless nodes from a plurality of cell clusters, there are specific adjustments that must be made in the VPN. FIG. 7 is a logical block diagram illustrating one sample embodiment of a VPN in which a mix of wireless and wired nodes are included. This figure includes the logical block diagram of FIG. 2 but with additional elements. Coupled to the intelligent peripheral 22 is a data network 160 that is preferably an IP network such as the Internet. Further coupled to the data network 160 is a web-based server 162 that is further coupled to a Local Area Network (LAN) 164. As seen in FIG. 7, first and second data apparatus are coupled to the LAN 164, the data apparatus 166,168 possibly being computers, printers, and/or scanners. It should be understood that more or less than two data apparatus could be included within an LAN such as the LAN 164.

In the sample embodiment of FIG. 7, the intelligent peripheral 22 includes a first private network group table and the web-based server 162 includes a second private network group table; these two tables together allowing for the establishment of a VPN between the first, second and third mobile stations 32,34,36 and the first and second data apparatus 166,168. FIGS. 8A and 8B illustrate possible implementations for the first and second private network group tables respectively that could be used within the intelligent peripheral 22 and the web-based server 162 respectively of FIG. 7. These private network group tables preferably each include entries for each of the nodes (mobile stations and data apparatus) of the VPN; each entry comprising a node registration and a data address. The data address is preferably the unique IP address assigned to a particular node. The node registration, on the other hand, is preferably the identification used to route data packets through the VPN.

Within the first private network group table of FIG. 8A, the node registrations for the mobile stations 32,34,36 are the HLRs corresponding to the mobile stations while the node registration for both the data apparatus 166,168 is the IP address of the web-based server 162, in this case 10.1.2.0. In the case of the mobile stations 32,34,36, their HLRs are used by the intelligent peripheral 22 when forwarding packets that have their IP address as the destination address. In the case of the data apparatus 166,168, a second IP header having a destination address of the IP address of the web-based server 162 is preferably attached to packets that have either of the data apparatus' IP addresses as the destination address. These packets with two IP encapsulations are then forwarded to the web-based server 162 via the data network 160, at which point the second IP header is removed and the original packet is processed at the web-based server 162.

The use of the second private network group table of FIG. 8B is similar to that described above for the first table but in opposite functionality. Within the second private network group table, the node registrations for all of the mobile stations 32,34,36 is the IP address of the intelligent peripheral 22, in this case 10.1.1.0, while the node registration for the data apparatus 166,168 is the internal address of the particular apparatus, in this case their particular IP addresses. In the case of the data apparatus 166,168, their IP addresses are used by the server 162 when forwarding packets that have their IP address as the destination address. In the case of the mobile stations 32,34,36, a second IP header including the IP address of the intelligent peripheral 22 is preferably attached to packets that have one of the mobile stations' IP addresses as the destination address. These packets with two IP encapsulations are then forwarded to the intelligent peripheral 22 via the data network 160, at which point the second IP header is removed and the original packet is processed at the intelligent peripheral 22.

Within the sample embodiment of FIG. 7, the intelligent peripheral 22 and the web-based server 162 determine whether two apparatus are within the same VPN with use of the node registrations. When a packet arrives, it is determined whether the node registration corresponding to its destination address is within the same private network group table as the originating node's node registration. If a packet was forwarded to the intelligent peripheral 22 from one of the mobile stations within its cell cluster, the HLR of the particular mobile station is used as the originating node's node registration. If a packet was forwarded to the web-based server 162 from one of the data apparatus within its LAN, the IP address of the particular data apparatus is used as the originating node's node registration. If a packet was forwarded to either the server 162 or the peripheral 22 from another web-based server or intelligent peripheral, the IP address of the originating server/peripheral is used as the originating node's node registration.

In this configuration an intelligent peripheral or a web-based server can support more than one private network group table at one time. As such, each web-based server and intelligent peripheral must have distinct IP addresses assigned for each private network group that it supports.

The sample embodiment of FIG. 7 is not limited to the case of a single intelligent peripheral 22 and a single web-based server 162. This embodiment could be expanded to include a plurality of both components or simply a plurality of one type of component and none of the other. It should also be recognized, in the case that the VPN has its nodes being mobile stations within a variety of different cell clusters, there are alternatives to the use of a data network such as data network 160 to interconnect them. For instance, the interconnections of the intelligent peripherals for each cell cluster could occur via the interconnection of their respective MSCs, that being with use of Custom Local Area Signalling Services (CLASS) such as SS7 signalling.

There are numerous alternative embodiments to the interface apparatus according to preferred embodiments of the present invention described herein above. For one, a different wireless standard to the IMT-2000 standard defined by the ITU could be utilized as long as it has the minimum functionality required to operate the present invention. In other standards, another component other than the RNC could be used to control the adjusting of bandwidths between mobile stations and BTSs.

There a number of other limitations that were suggested in the sample operations described above that should not limit the scope of the overall present invention. For one, it should be understood that a mobile station such as an interface apparatus according to preferred embodiments could be part of more than one VPN by simply being a member of more than one private network group table. As well, although the operations herein above describe cases in which a first mobile station can only access a second mobile station if they are both within the same VPN, some embodiments of the present invention would further allow the first mobile station to access other mobile stations or apparatus that are not specifically part of the VPN, such as an Internet server. This would allow a user of a computer within a VPN to access the other devices of the VPN as well as possibly the public Internet. This embodiment would preferably be implemented with use of a well-known firewall within the intelligent peripheral 22.

In yet further alternatives, the intelligent peripheral 22 determines whether data information is of a type that requires a limited access and, if the particular data information does not require limited access, processes the data information (i.e. forwards it) without regard to whether the sending and receiving mobile stations are within the same private network group. In the case that limited access is required, one should understand that the operation of the intelligent peripheral 22 for a VPN, as described above, would result.

Even further, although the description herein above is directed to the transfer of data information from a wireless network to an interface apparatus to another component, it should be understood that this data could be voice over IP packets or other packet-based units designed to carry voice signals over a data network. In general, the data information being transferred from apparatus to apparatus can be referred to as data units, these data units possibly being defined by one of a number of standards. Internet Protocol (IP) packets and Asynchronous Transfer Mode (ATM) cells are two example implementations of possible data units.

The present invention overall allows a large number of the advantages of a wired network design to be available to users in a wireless environment. For one, members of the mobile workforce using embodiments of the present invention can gain access to printers, scanners and other components not normally able to be implemented within a wireless environment. Further, a user of a computer can, with the implementation of preferred embodiments of the present invention, possibly print documents, scan documents, fax documents, etc. without actually being physically connected to printers, scanners, facsimile machines etc. All that is needed, in preferred embodiments, is the IP address corresponding to the particular component that the user wants to access. Further, the implementation of preferred embodiments of the present invention could be used to remove some or all of the large wired networks that are typically within an enterprise, thus making reconfiguration during the addition/removal of components much easier.

Persons skilled in the art will appreciate that there are yet more alternative implementations and modifications possible for implementing the present invention, and that the above implementation is only an illustration of this embodiment of the invention. The scope of the invention, therefore, is only to be limited by the claims appended hereto.

We claim:

1. An apparatus for controlling data communications between a component interface port and a wireless network transceiver, the apparatus comprising:
means for receiving digital data from the component interface port;
means for attaching a data unit overhead including source and destination addresses to the digital data in order to generate a data unit, the source address being a predefined data address for the apparatus and the destination address being a stored data address; and
means for outputting the data unit to the wireless network transceiver for transmission to a wireless network.

2. An apparatus according to claim 1 further comprising means for receiving a second data unit from the wireless network transceiver that comprises second digital data and a second data unit overhead including second source and destination addresses, the second destination address being the predefined data address for the computing device; means for removing the second data unit overhead from the second data unit; and means for outputting the second digital data to the component interface port.

3. An apparatus according to claim 2 further comprising means for storing the second source address.

4. An apparatus according to claim 1, wherein the source and destination addresses are Internet Protocol (IP) addresses.

5. An apparatus for controlling data communications between a component interface port and a wireless network transceiver, the apparatus comprising:
means for receiving a data unit from the wireless network transceiver that comprises digital data and a data unit overhead including source and destination addresses, the destination address being a predefined data address for the computing device;
means for removing the data unit overhead from the data unit; and
means for outputting the digital data to the interface port.

6. An apparatus according to claim 5 further comprising means for storing the source address.

7. An apparatus according to claim 5, wherein the source and destination addresses are Internet Protocol (IP) addresses.

8. An interface apparatus arranged to be coupled to a digital data processing component, the interface apparatus comprising:
an interface port comprising means for receiving digital data in a first format from the digital data processing component, means for converting the digital data from the first format to a second format, and means for outputting the digital data in the second format;
a computing device, coupled to the interface port, comprising means for receiving the digital data in the second format from the interface port; means for attaching a data unit overhead including source and destination addresses to the received digital data in order to generate a data unit, the source address being a predefined data address for the interface apparatus and the destination address being a stored data address; and means for outputting the data unit; and
a wireless network transceiver, coupled to the computing device, comprising means for receiving the data unit and means for transmitting it to a wireless network.

9. An interface apparatus according to claim 8, wherein the wireless network transceiver further comprises means for receiving a second data unit from the wireless network that comprises second digital data in the second format and a second data unit overhead including second source and destination addresses, the second destination address being the predefined data address for the interface apparatus, and means for outputting the second data unit;
wherein the computing device further comprises means for receiving the second data unit from the wireless network transceiver, means for removing the second data unit overhead from the second data unit, and means for outputting the second digital data in the second format; and
wherein the component interface port further comprises means for receiving the second digital data in the second format, means for converting the received digital data from the second format to the first format, and means for outputting the second digital data in the first format to the digital data processing component.

10. An interface apparatus according to claim 9, wherein the computing device further comprises means for storing the second source address.

11. An interface apparatus according to claim 10 further comprises a memory device comprising means for storing the second source address means for storing the predefined data address for the interface apparatus.

12. An interface apparatus according to claim 8, wherein the component interface port is a Universal Serial Bus (USB) port and the first format is a format required for transmitting digital data over a USB cable.

13. An interface apparatus according to claim 8, wherein the wireless network transceiver is a third generation (3G) wireless network transceiver.

14. An interface apparatus according to claim 8, wherein the source and destination addresses are Internet Protocol (IP) addresses.

15. An interface apparatus arranged to be coupled to a digital data processing component, the interface apparatus comprising:
a wireless network transceiver comprising means for receiving a data unit from a wireless network that comprises digital data in a first format and a data unit overhead including source and destination addresses, the destination address being a predefined data address for the interface apparatus, and means for outputting the data unit;
a computing device, coupled to the wireless network transceiver, comprising means for receiving the data unit from the wireless network transceiver, means for removing the data unit overhead from the data unit, and means for outputting the digital data in the first format; and
a component interface port, coupled to the computing device, comprising means for receiving the digital data in the first format, means for converting the received digital data from the first format to a second format, and means for outputting the digital data in the second format to the digital data processing component.

16. An interface apparatus according to claim 15, wherein the computing device further comprises means for storing the source address.

17. An interface apparatus according to claim 15, wherein the component interface port is a Universal Serial Bus (USB) port and the second format is a format required for transmitting digital data over a USB cable.

18. An interface apparatus according to claim 15, wherein the wireless network transceiver is a third generation (3G) wireless network transceiver.

19. An interface apparatus according to claim 15, wherein the source and destination addresses are Internet Protocol (IP) addresses.

20. Within an interface apparatus, a method of transmitting digital data received from a digital data processing component to a wireless network, the method comprising:
receiving digital data in a first format from the digital data processing component;
converting the digital data from the first format to a second format;
attaching a data unit overhead including source and destination addresses to the received digital data in order to generate a data unit, the source address being a predefined data address for the interface apparatus and the destination address being a stored data address; and
transmitting the data unit on the wireless network.

21. Within an interface apparatus, a method of forwarding digital data received within a data unit from a wireless network to a digital data processing component, the method comprising:
receiving the data unit from the wireless network, the data unit comprising digital data in a first format and a data unit overhead including source and destination addresses, the destination address being a predefined data address for the interface apparatus;
removing the data unit overhead from the data unit;
converting the received digital data from the first format to a second format; and
outputting the digital data in the second format to the digital data processing component.
